(19) United States
(12) Patent Application Publication
(10) Pub. No.: US 2016/0001747 A1
(43) Pub. Date: Jan. 7, 2016

(54) CLEANING SYSTEM FOR MACHINE

(71) Applicant: CATERPILLAR INC., Peoria, IL (US)

(72) Inventor: Jeffery J. Doll, Oglesby, IL (US)

(21) Appl. No.: 14/322,945

(22) Filed: Jul. 3, 2014

(51) Int. Cl. B60S 1/50; F25D 21/14

(52) U.S. Cl. CPC B60S 1/50; F25D 21/14

(57) ABSTRACT

A system for a machine having an air conditioning unit is provided. The system includes a first conduit in fluid communication with an evaporator module of the air conditioning unit. The first conduit is configured to receive a condensed liquid from the evaporator module. The system also includes a second conduit in fluid communication with the first conduit. The system further includes a reservoir configured to store a liquid therein. The reservoir is in fluid communication with the second conduit and a cleaning system of the machine. The system further includes a third conduit in fluid communication with the second conduit. The third conduit is configured to inhibit a flow of the liquid from the reservoir to the evaporator module.

### TECHNICAL FIELD

The present disclosure relates to a cleaning system, and more particularly to a cleaning system for a machine having an air conditioning unit.

### BACKGROUND

Machines, for example, mining trucks, generally include a cleaning system. The cleaning system may be configured to dispense a cleaning fluid onto a windshield of the machine. The cleaning system includes the cleaning fluid stored in a fluid reservoir. The cleaning fluid may be sprayed onto the windshield and wiped off by windshield wipers, thereby cleaning debris and/or dust from a surface of the windshield. When a level of the cleaning fluid within the fluid reservoir drops, the fluid reservoir may be refilled with the cleaning fluid using a fill system.

U.S. Application Publication Number 2004/237561 describes a system for utilizing water originating from an air conditioning system in order to supply water to an automobile windshield wiper system. The system includes air conditioning generating equipment for an automobile. The air conditioning generating equipment including a compressor, a condenser, and an evaporating compartment. The air conditioning generating equipment includes a water-collecting container positioned below a level of the evaporating compartment. The air conditioning generating equipment includes a first tubing for connecting the evaporating compartment to the water-collecting container to supply water from the evaporating compartment to the water-collecting container and a second tubing for connecting the water-collecting container to a windshield wiper system of the automobile. The air conditioning generating equipment also includes a pump for pumping the water from the water-collecting container to the windshield wiper system through the second arrangement. The container has an exit that eliminates excess water to prevent such water from returning to the evaporation compartment. However, the location of the container's exit proximate to the location where the first tubing is coupled to the container facilitates the underutilization of the entire capacity of the container. The location of the container's exit also does not provide any indication via the manual fill line to the person filing the container with the manual fill line on how much to continuously pour in, thereby allowing cleaning fluid to be wasted as it undesirably exits the container's exit.

### SUMMARY OF THE DISCLOSURE

In one aspect of the present disclosure, a system for a machine having an air conditioning unit is provided. The system includes a first conduit provided in fluid communication with an evaporator module of the air conditioning unit. The first conduit is configured to receive a condensed liquid from the evaporator module. The system also includes a second conduit provided in fluid communication with the first conduit. The system further includes a reservoir configured to store a liquid therein. The reservoir is provided in fluid communication with the second conduit and a cleaning system of the machine. The system further includes a third conduit in fluid communication with the second conduit. The third conduit is configured to inhibit a flow of the liquid from the reservoir to the evaporator module.

In another aspect of the present disclosure, a machine is provided. The machine includes a fluid collection system. The machine also includes a first conduit provided in fluid communication with the fluid collection system to drain a liquid therefrom. The machine further includes a cleaning system comprising a reservoir. The reservoir is configured to store the liquid therein. The machine includes a second conduit fluidly coupled between the first conduit and the reservoir of the cleaning system. The machine further includes a third conduit provided in fluid communication with the second conduit. The third conduit is configured to inhibit a flow of the liquid from the reservoir to the fluid collection system.

In yet another aspect of the present disclosure, a cleaning system for a machine having a fluid collection system is provided. The cleaning system includes a first conduit provided in fluid communication with the fluid collection system to drain a liquid therefrom. The cleaning system also includes a second conduit fluidly coupled to the first conduit. The machine further includes a reservoir configured to store the liquid therein, the reservoir being in fluid communication with the second conduit. The machine includes a liquid dispensing module provided in fluid communication with the reservoir. The liquid dispensing module is configured to selectively dispense the liquid therefrom. The machine also includes a third conduit provided in fluid communication with the second conduit. The third conduit is configured to inhibit a flow of the liquid from the reservoir to the fluid collection system.

Other features and aspects of this disclosure will be apparent from the following description and the accompanying drawings.

### BRIEF DESCRIPTION OF THE DRAWINGS

FIG. 1 is a perspective view of an exemplary machine;

FIG. 2 is a partial perspective view of a cleaning system of the machine, according to an embodiment of the present disclosure; and

FIG. 3 is a perspective view of a reservoir of the cleaning system, according to another embodiment of the present disclosure.

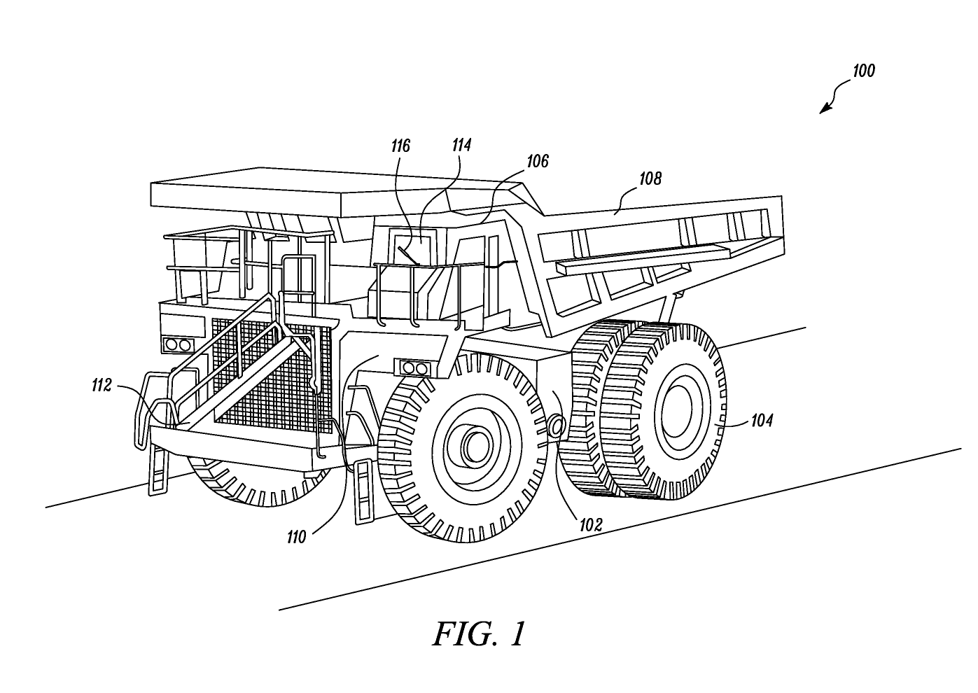

### DETAILED DESCRIPTION

Wherever possible, the same reference numbers will be used throughout the drawings to refer to the same or the like parts. FIG. 1 illustrates an exemplary machine 100. The machine 100, as shown in FIG. 1, may be a mining truck. However, the machine 100 may include any off-highway or on-highway vehicle using a fuel-powered engine. Alternatively, the machine 100 may include a backhoe loader, a skid steer loader, a motor grader, a load haul dumper, and the like. It should be understood that the machine 100 may also be used in transportation, forestry, agricultural, construction, or any other industry.

The machine 100 includes a machine frame 102. A powertrain (not shown) may be provided on the machine 100 for the production and transmission of motive power. The powertrain may include a power source, such as one or more engines, batteries, and the like. The power source may be provided within an enclosure of the machine 100. It should be noted that the power source may also be external to the machine 100.

A set of ground engaging members 104, such as wheels, may also be provided on the machine 100 for the purpose of mobility. The powertrain may include a power transmitting drive provided between the power source and the set of ground engaging members 104 for the transmission of motive power. In various examples, the power transmitting drive may include a mechanical drive, an electric drive, a hydraulic drive, or a combination thereof. As should be appreciated by one of ordinary skill in the art, the power source may power a variety of other machine systems, including various mechanical, electrical, and hydraulic systems and/or components.

The machine 100 may also include an operator control station 106 including various operator controls and displays used to operate the machine 100. The machine 100 may further include a dump body 108 which may be pivotal relative to the machine frame 102. The operator control station 106 may be mounted on a platform 110 of the machine 100. An operator of the machine 100 may access the operator control station 106 and the platform 110 using ladders 112 provided on the machine 100.

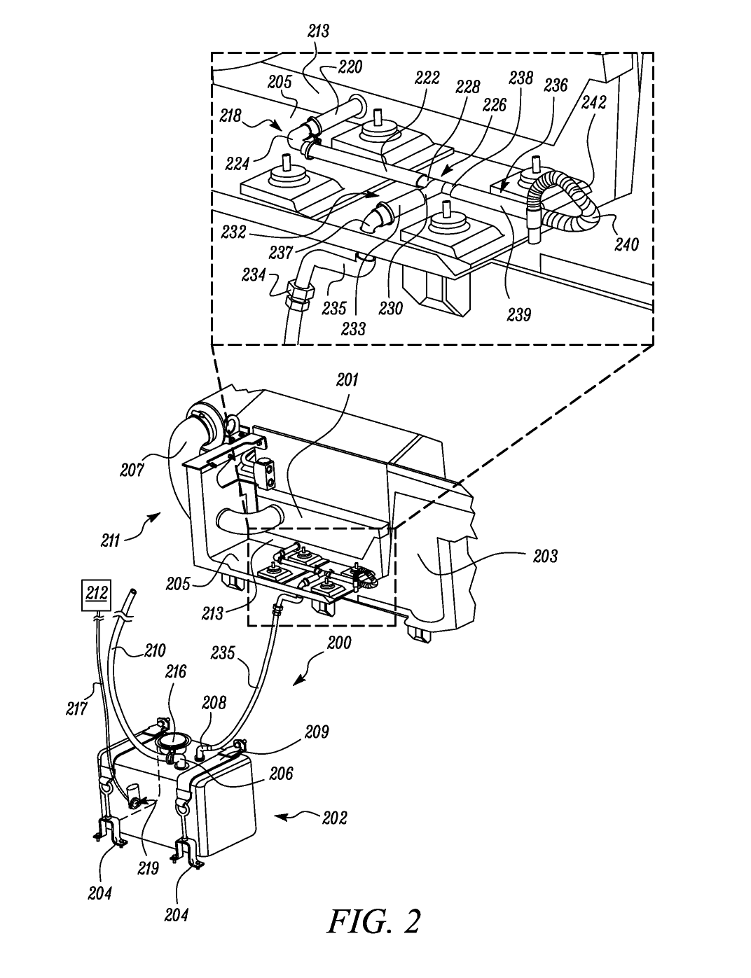

In one embodiment, an air conditioning unit 211 (see FIG. 2) may be provided on the machine 100. Some components of the air conditioning unit 211 may be provided on the platform 110, and adjacent to the operator control station 106. The air conditioning unit 211 may be configured to regulate environmental factors within the operator control station 106 in order to provide a comfortable operating environment for an operator of the machine 100. The environmental factors may include temperature, humidity, ventilation, and the like. The air conditioning unit 211 may be configured to provide both heating and cooling within the operator control station 106 based on ambient weather conditions.

Further, the air conditioning unit 211 may operate on a refrigeration cycle known to a person of ordinary skill in the art, and may include, among other components, a compressor (not shown), a condenser (not shown), an expander (not shown), and an evaporator module 201 (shown in FIG. 2). A refrigerant is pressurized by the compressor and flows through each of the components including the evaporator module 201. It may be contemplated that a direction of flow of the refrigerant within the air conditioning unit 211 may be controlled based on whether the air conditioning unit 211 is providing heating or cooling. Further, the air conditioning unit 211 may also be configured to regulate environmental factors associated with other components of the machine 100 in addition to the operator control station 106.

FIG. 2 illustrates a support structure 203 that may be mounted on the platform 110 (shown in FIG. 1). The support structure 203 may be mounted adjacent to the operator control station 106. A base 205 may be extended between opposite sides of the support structure 203. In one example, the base 205 may be integrally formed with the support structure 203. In another example, the base 205 may be provided with the air conditioning unit 211. The support structure 203 may house various machine components. However, these components are not shown in FIG. 2 for clarity purposes. In one example, the support structure 203 may house one or more components of the air conditioning unit 211, for example, the evaporator module 201. The evaporator module 201 of the air conditioning unit 211 may include heat exchange coils (not shown).

A duct 207 may be provided in fluid communication with an interior of the operator control station 106 and the evaporator module 201. A blower (not shown) may draw air from inside the operator control station 106. Ambient air may also be drawn into the duct 207 and mixed with air from the operator control station 106. Air from the duct 207 may be then blown across the heat exchange coils. The refrigerant flowing through the heat exchange coils of the evaporator module 201 may exchange heat with air flowing across the heat exchange coils. Due to the heat exchange, a temperature of air may decrease. Cooled air may be recirculated within the operator control station 106 via one or more vents (not shown), thereby cooling the operator control station 106.

Further, on account of the heat exchange between air and the refrigerant flowing through the heat exchange coils, water vapor present in air may condense to liquid state on an outer surface of the heat exchange coils of the evaporator module 201. The condensed liquid may drip and accumulate in a fluid collection system 213. The fluid collection system 213 may be provided within the evaporator module 201, and below the heat exchange coils. The fluid collection system 213 may include a pan and a drain line attached thereto. The condensed liquid may drain out from the fluid collection system 213 through the drain line.

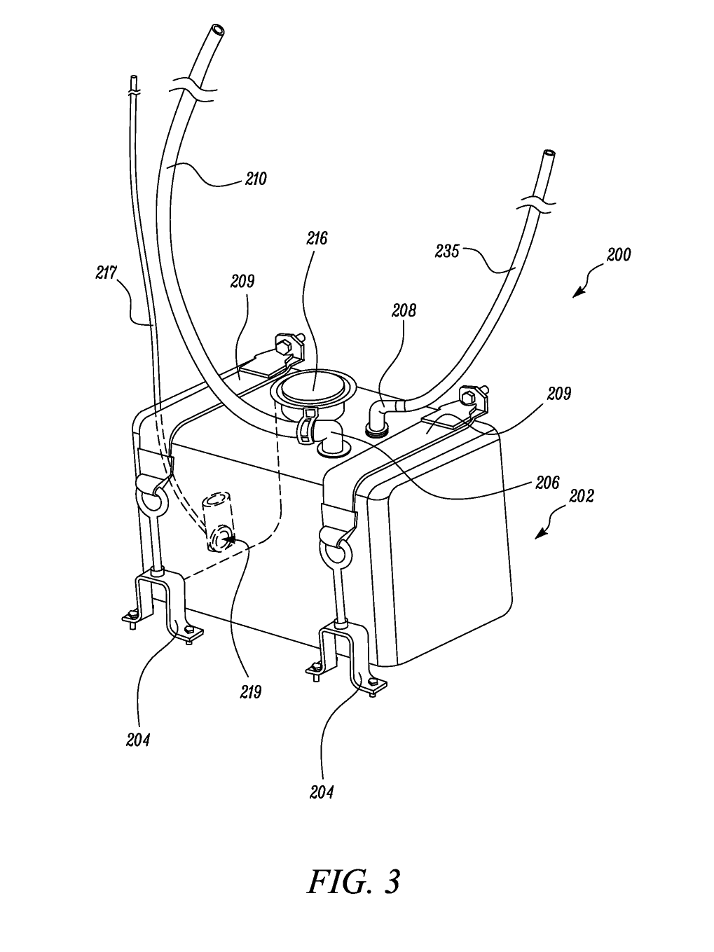

In an embodiment, the machine 100 also includes a cleaning system 200. The cleaning system 200 may be used to clean lenses of cameras, front windshield 114 (shown in FIG. 1), and/or rear windshield of the machine 100. In the illustrated embodiment, the cleaning system 200 includes a windshield cleaning system 212 (shown schematically in FIG. 2) which receives a cleaning liquid, for example, water, from a reservoir 202. The windshield cleaning system 212 is configured to deliver the cleaning liquid onto the windshield 114. The cleaning system 200 is used in conjunction with a front windshield wiper 116 to clean dust and/or debris from the front windshield 114 of the machine 100. The cleaning system 200 may include the reservoir 202. The reservoir 202 is configured to store the cleaning liquid therein. Details of the cleaning system 200 will be described hereinafter with reference to FIGS. 2 and 3.

As illustrated in the accompanying figures, the cleaning system 200 of the present disclosure includes a first conduit 218, a second conduit 232, and a third conduit 236. Each of the first, second, and third conduits 218, 232, 236 may be supported on the base 205 of the support structure 203 using one or more clips (not shown). A person of ordinary skill in the art would appreciate that the first, second, and third conduits 218, 232, 236 disclosed herein may embody any pipe, tube, hose, and the like, which allows a fluid to flow therethrough. The first, second, and third conduits 218, 232, 236 may be made of metal, plastic, composites or the like.

The first conduit 218 of the cleaning system 200 is provided in fluid communication with the drain line of the fluid collection system 213. The first conduit 218 is positioned vertically below the evaporator module 201, such that the condensed liquid from the fluid collection system 213 is received within the first conduit 218. The first conduit 218 includes a first portion 220 and a second portion 222. The first portion 220 of the first conduit 218 is provided proximate to the fluid collection system 213 and is coupled to the drain line of the fluid collection system 213. The second portion 222 of the first conduit 218 may extend from an end of the first portion 220. In an embodiment, the first portion 220 and the second portion 222 of the first conduit 218 are fluidly coupled to each other at right angles by a fluid connector 224, shown, e.g., as an elbow.

The cleaning system 200 of the present disclosure further includes a fluid coupling 226. In the illustrated embodiment, the fluid coupling 226 is embodied as a Tee connector. Alternatively, the fluid coupling 226 may be any known mechanical coupling configured to connect two or more pipes, tubes etc. A first end 228 of the fluid coupling 226 may be threadably attached to the second portion 222 of the first conduit 218. Further, a second end 230 of the fluid coupling 226 may be disposed perpendicular to the first end 228, e.g., as shown in FIG. 2. The second end 230 may be fluidly coupled with the second conduit 232. In one example, the second end 230 may be configured to receive the second conduit 232. The second conduit 232 includes a first portion 233. As shown in FIG. 2, the first portion 233 of the second conduit 232 may be positioned perpendicularly with respect to the second portion 222 of the first conduit 218. The second conduit 232 also includes a second portion 235. The second portion 235 may be fluidly coupled with the first portion 233 by a fluid connector 237, shown, e.g., as an elbow. The fluid connector 237 may be provided within an aperture formed within the base 205 of the support structure 203.

Further, the platform 110 (shown in FIG. 1) may include a connector 234 provided within a through-hole formed within the platform 110. The connector 234 can support the second portion 235 of the second conduit 232 passing therethrough. The second portion 235 of the second conduit 232 is configured to fluidly connect the first portion 233 of the second conduit 232 with the reservoir 202 of the cleaning system 200. The cleaning system 200 also includes the third conduit 236. The third conduit 236 includes a first portion 239. The first portion 239 of the third conduit 236 may be coupled to a third end 238 of the fluid coupling 226. The third end 238 of the fluid coupling 226 may be co-axial with the first end 228. Therefore, when received within the third end 238 of the fluid coupling 226, the first portion 239 of the third conduit 236 may be co-axial with the second portion 222 of the first conduit 218. The outer ends of the fluid coupling 226 may be threaded for engagement along the inside of the first, second, and third conduits 218, 232, 236.

The third conduit 236 disclosed herein includes a drainage portion 240. The drainage portion 240 includes an elevated loop 242. The elevated loop 242 of the drainage portion 240 is provided such that, a curve of the elevated loop 242 is at a higher elevation with respect to the base 205 of the support structure 203. Further, the drainage portion 240 is provided within the cleaning system 200 such that the drainage portion 240 is positioned vertically between the first conduit 218 and the fluid collection system 213 of the evaporator module 201. In one embodiment, the drainage portion 240 may embody a flexible pipe made of rubber or plastic.

FIG. 3 illustrates a perspective view of the reservoir 202. Referring to FIGS. 2 and 3, the reservoir 202 may have a substantially cuboidal shape. Further, brackets 204 connected with straps 209 may be provided in association with the reservoir 202 in order to couple the reservoir 202 to the platform 110. The reservoir 202 is positioned within the platform 110 such that the evaporator module 201 is positioned vertically above the reservoir 202. More particularly, the evaporator module 201 is provided at a higher elevation with respect to the reservoir 202.

The reservoir 202 disclosed herein may include a first cavity and a second cavity provided on a top portion of the reservoir 202. Each of the first and second cavities is configured to receive a first fluid connector 206 and a second fluid connector 208, respectively. The first and second fluid connectors 206, 208 receive a first tube 210 and the second portion 235 of the second conduit 232, respectively. Each of the first tube 210 and the second portion 235 is configured to introduce the cleaning liquid within the reservoir 202. The first tube 210 may embody any hose, pipe, and the like, which allows a fluid to pass therethrough. The function of each of the first tube and second portion 210, 235 will be discussed later in this disclosure. The reservoir 202 may include a cap 216 provided on the top portion of the reservoir 202. The cap 216 may be sonically welded to the reservoir 202.

During machine operation, it may be desirable that the reservoir 202 has an adequate amount of the cleaning liquid therein. A low level of the cleaning liquid within the reservoir 202 may lead to a failure of the cleaning system 200, thereby affecting operator visibility. Accordingly, the operator may have to periodically refill the reservoir 202 with the cleaning liquid. In an exemplary embodiment, the reservoir 202 of the cleaning system 200 may be manually filled using a remote fill system (not shown). The remote fill system may be fluidly coupled to the reservoir 202 via the first tube 210. During a refilling operation of the reservoir 202, the first tube 210 receives a cleaning liquid from the remote fill system, and introduces the same into the reservoir 202. The remote fill system may be accessible on the platform 110 of the machine 100.

In another exemplary embodiment, the reservoir 202 may be refilled by the condensed liquid accumulated in the fluid collection system 213. As discussed earlier, during an operation of the air conditioning unit 211, the condensed liquid may be continuously formed and collected within the fluid collection system 213. Referring to FIG. 2, the condensed liquid may flow into the first conduit 218, via the drain line of the fluid collection system 213. The condensed liquid may then flow and be introduced within the reservoir 202 via the first and second portions 233, 235 of the second conduit 232.

In one situation, the cleaning liquid being received by the reservoir 202 may exceed a liquid holding capacity of the reservoir 202. In such a situation, the condensed liquid may tend to flow back into the fluid collection system 213 via the first and second conduits 218, 232. The third conduit 236, which is provided in fluid communication with the first and second conduits 218, 232, is configured to inhibit a flow of the cleaning liquid from the reservoir 202 back into the fluid collection system 213. An excess amount of the cleaning liquid returning from the reservoir 202 may flow through the second portion 235, the first portion 233, and, subsequently through the first portion 239 of the third conduit 236. The cleaning liquid may then flow through the elevated loop 242 of the drainage portion 240, thereby avoiding a flow of the cleaning liquid towards the evaporator module 201. The elevated loop 242 of the drainage portion 240 may also prevent drainage of the condensed liquid during the flow of the condensed liquid from the fluid collection system 213 to the reservoir 202, as the elevated loop 242 is positioned vertically between the base 205 of the support structure 203 and the evaporator module 201. Therefore, the drainage portion 240 may not interfere with the refilling of the reservoir 202. Further, the cleaning liquid that tends to flow back form the reservoir 202 may drain out of the machine 100 via a drain port (not shown).

The cleaning system 200 of the present disclosure also includes a liquid dispensing module (not shown). The liquid dispensing module may be configured to selectively dispense or spray the cleaning liquid from the reservoir 202 onto the windshield 114 (shown in FIG. 1) of the machine 100. In one example, the reservoir 202 may contain a mixture of the condensed liquid form the evaporator module 201 and the cleaning liquid from the remote fill system. The liquid dispensing module may include a pump (not shown) provided in fluid communication with the reservoir 202 via an outlet tube 217. The outlet tube 217 is connected to an outlet 219 of the reservoir 202. The outlet 219 of the reservoir 202 may include a check valve configured to allow unidirectional flow from the reservoir 202 to the liquid dispending module. The pump may be configured to pressurize the cleaning liquid present within the reservoir 202, and deliver the same to spray nozzles (not shown) arranged in front of the windshield 114. The spray nozzles may spray the cleaning liquid on to the windshield 114 based on a command from the operator.

The cleaning system 200, as described with reference to FIGS. 2 and 3, are exemplary in nature and various alternative configurations are possible within the scope of the present disclosure. For example, the first, second, and third conduits 218, 232, 236 may have an integral construction. Further, one or more valves may be disposed on one or more of the first, second, and third conduits 218, 232, 236.

### INDUSTRIAL APPLICABILITY

Machines equipped with a windshield cleaning system generally include a fluid reservoir carrying the cleaning fluid. An absence of the cleaning fluid within the fluid reservoir may affect the operator's visibility, thereby arising safety concerns. Accordingly, in a situation wherein a level of the cleaning fluid within the fluid reservoir drops, the fluid reservoir may have to be refilled with the cleaning fluid. Known solutions use a manual fill system for refilling the fluid reservoir with the cleaning fluid. However, the process of manually refilling the fluid reservoir may be inconvenient and time consuming for the operator. Further, the known solution may also affect the productivity of the operator as the operator may have to abandon an ongoing task in order to refill the fluid reservoir.

The present disclosure contemplates providing the cleaning system 200 for refilling the reservoir 202 with minimum operator intervention. More particularly, the cleaning system 200 of the present disclosure makes use of the condensed liquid dripping from the heat exchange coils of the evaporator module 201 and collected within the fluid collection system 213 to refill the reservoir 202. The cleaning system 200 includes the first and second conduits 218, 232, wherein the first conduit 218 is fluidly coupled to the second conduit 232. Further, the first conduit 218 is fluidly coupled with the drain line of the fluid collection system 213, such that the condensed liquid from the fluid collection system 213 is introduced within the reservoir 202 by the first and second conduits 218, 232 respectively.

The cleaning system 200 disclosed herein also includes the third conduit 236 embodied as an overflow conduit. The third conduit 236 includes the drainage portion 240. The first portion 239 and the drainage portion 240 of the third conduit 236 disclosed herein are configured to receive the excess amount of the cleaning liquid returning from the reservoir 202, thereby avoiding a flow of the cleaning liquid from the reservoir 202 back to the fluid collection system 213 of the evaporator module 201. Elevating the drainage portion 240 above the reservoir 202 can permit greater utilization of the entire capacity of the reservoir 202 to store the cleaning liquid. By positioning the drainage portion 240 vertically between the lower first conduit 218 and the higher evaporator module 201 can facilitate the routing of the cleaning liquid out of the drainage portion 240 rather than returning to the evaporator module 201.

The cleaning system 200 retains the ability of the machine 100 to refill the reservoir 202 using the remote fill system. The reservoir 202 may need to be manually filled with the cleaning liquid only once before the start of an operation on the machine 100. Further, when the air conditioning unit 211 is in operation, the cleaning system 200 may replenish the reservoir 202 with the condensed liquid. Also, in a situation where ambient conditions are not favorable for the continuous formation of the condensed liquid, the operator of the machine 100 may use the remote fill system to manually fill the reservoir 202 with the cleaning liquid. The elevation of the drainage portion 240 above the reservoir 202 can facilitate the provision of visual indication via the first tube 210 to the person filling the reservoir 202 by way of the first tube 210 on how much cleaning liquid to pour in. Instead of the cleaning liquid dumping immediately outside the reservoir 202, when the drainage portion 240 is provided at the reservoir 202, the person will visually notice the cleaning liquid gradually rising within the first tube 210, thereby indicating that the reservoir 202 is filled and thus allowing the person to take actions to inhibit the cleaning liquid from being wasted.

The cleaning system 200 may ensure a continuous supply of the condensed liquid in to the reservoir 202, which would otherwise drain out of the machine 100. Hence, the refilling of the reservoir 202 using the condensed liquid may eliminate the need of periodic refilling of the reservoir 202 with the additional supply of the cleaning liquid. Further, the cleaning system 200 disclosed herein has a modular construction including the first, second, and third conduits 218, 232, 236, thereby facilitating installation on existing machines having the air conditioning unit 211. One of ordinary skill in the art will appreciate that the system of the present disclosure may be utilized in connection with a variety of machines and is not limited to that of the application disclosed herein.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for a machine having an air conditioning unit, the system comprising:
a first conduit in fluid communication with an evaporator module of the air conditioning unit, the first conduit configured to receive a condensed liquid from the evaporator module therein;
a second conduit in fluid communication with the first conduit;
a reservoir configured to store a liquid therein, the reservoir being in fluid communication with the second conduit and a cleaning system of the machine; and
a third conduit in fluid communication with the second conduit, the third conduit configured to inhibit a flow of the liquid from the reservoir to the evaporator module.

2. The system of claim 1, wherein the third conduit comprises a drainage portion distal to the first conduit, the drainage portion vertically positioned between the lower first conduit and the higher evaporator module.

3. The system of claim 2, wherein the evaporator module is vertically positioned above the reservoir.

4. The system of claim 1, wherein the evaporator module comprises a fluid collection system configured to collect the condensed liquid therein, and wherein the first conduit is coupled to the fluid collection system to drain the condensed liquid therefrom.

5. The system of claim 1, further comprises a fluid coupling configured to couple the first conduit to the second conduit and the third conduit such that the first conduit, the second conduit, and the third conduit are in fluid communication with one another.

6. The system of claim 1, wherein a connector is disposed around a portion of the second conduit, the connector is configured to be received in an opening of a platform of the machine.

7. The system of claim 1, wherein the first conduit comprises:
a first portion proximate to the evaporator module;
a second portion extending from the first portion to couple to the second conduit and the third conduit; and
a fluid connector fluidly connecting the first portion and the second portion.

8. The system of claim 1, wherein the reservoir includes a first fluid connector configured to couple to the second conduit with a cavity of the reservoir and a second fluid connector configured to fluidly connect a manual fill conduit with the cavity of the reservoir.

9. The system of claim 8, wherein the reservoir further comprises a vent conduit.

10. The system of claim 1, wherein the cleaning system comprises a windshield cleaning system of the machine.

11. A machine comprising:
a fluid collection system;
a first conduit in fluid communication with the fluid collection system to drain a liquid therefrom;
a cleaning system comprising a reservoir configured to store the liquid therein;
a second conduit fluidly coupled between the first conduit and the reservoir of the cleaning system; and
a third conduit in fluid communication with the second conduit, the third conduit configured to inhibit a flow of the liquid from the reservoir to the fluid collection system.

12. The machine of claim 11, wherein the third conduit comprises a drainage portion distal to the first conduit, the drainage portion vertically positioned between the lower first conduit and the fluid collection system.

13. The machine of claim 12, wherein the fluid collection system is vertically positioned above the reservoir.

14. The system of claim 11, wherein the reservoir includes a first fluid connector configured to couple to the second conduit with a cavity of the reservoir and a second fluid connector configured to fluidly connect a manual fill conduit with the cavity of the reservoir.

15. The system of claim 14, wherein the reservoir further comprises a vent conduit.

16. The machine of claim 11, further comprises a fluid coupling configured to couple the first conduit to the second conduit and the third conduit such that the first conduit, the second conduit, and the third conduit are in fluid communication with one another.

17. A cleaning system for a machine having a fluid collection system, the cleaning system comprising:
a first conduit in fluid communication with the fluid collection system to drain a liquid therefrom;
a second conduit fluidly coupled to the first conduit;
a reservoir configured to store the liquid therein, the reservoir being in fluid communication with the second conduit;
a liquid dispensing module in fluid communication with the reservoir, the liquid dispensing module configured to selectively dispense the liquid therefrom; and
a third conduit in fluid communication with the second conduit, the third conduit configured to inhibit a flow of the liquid from the reservoir to the fluid collection system.

18. The cleaning system of claim 17, wherein the third conduit comprises a drainage portion distal to the first conduit, the drainage portion vertically positioned between the lower first conduit and the higher fluid collection system.

19. The cleaning system of claim 18, wherein the fluid collection system is vertically positioned above the reservoir.

20. The cleaning system of claim 17, wherein the reservoir includes a first fluid connector configured to couple to the second conduit with a cavity of the reservoir and a second fluid connector configured to fluidly connect a manual fill conduit with the cavity of the reservoir.
